(19) United States
(12) Patent Application Publication
(10) Pub. No.: US 2026/0187703 A1
(43) Pub. Date: Jul. 2, 2026

(54) MULTIMODAL LARGE LANGUAGE LEARNING MODEL FOR AUGMENTING LISTINGS

(71) Applicant: eBay Inc., San Jose, CA (US)

(72) Inventor: Shrivatsan Navalpakkam Rajagopalan, San Jose, CA (US)

(21) Appl. No.: 19/003,897

(22) Filed: Dec. 27, 2024

(51) Int. Cl. G06Q 30/0601

(52) U.S. Cl. CPC G06Q 30/0633; G06Q 30/0643

(57) ABSTRACT

A machine learning model that augments a listing is provided. The model receives an item associated with a first listing and extracts a first vector representation comprising a first characteristic from the image content. The model searches a corpus for a second vector representation having a second characteristic using the first vector representation. The corpus has second vector representations associated with the second items. The model compares the first characteristic with the second characteristic and determines a match between the first vector representation and the second vector representation. The second characteristic is associated with a second item that is associated with a second listing. The model augments the first listing based on the second listing and displays the augmented first listing.

### TECHNICAL FIELD

Examples of the present disclosure relate generally to multimodal large language learning models and, more particularly, but not by way of limitation, to training a multimodal large language learning model to augment an item listing.

### BACKGROUND

A user may desire to sell an item, such as a chestnut cow suede bomber jacket. However, the user may not be aware that in order to sell the item, certain information that describes the item should be included. In the bomber jacket example, the seller should indicate that the jacket is a bomber jacket made of cow suede having a chestnut color. This can be based on how successful other users have sold similar bomber jackets and the desires of those interested in buying bomber jackets. Instead, the seller may just provide an image content of the jacket and indicate that the jacket is brown and made of leather. The lack of information could cause the bomber jacket to go unsold.

Accordingly, technical problems exist with computing devices. In particular, a computing device lacks the capability to ascertain the importance of certain data, access this data, and then presenting this data.

### SUMMARY

Examples relate to a system and method that uses a multimodal large language learning model to extract readable text from an image content and transpose the readable text into human readable text. The image content can relate to a first item and the system can augment a first listing associated with the item with the human readable text. The system can transpose the human readable text into a first type and a second type different from the first type, such as a first language and a second language that is different from the first language.

The system can include a corpus of categories transcoded into vector representations. The corpus of categories can correspond to second items having characteristics that are similar to characteristics of the first item. The second items can also be associated with second listings. The second listings can be a framework which can be used to augment the first listing. The framework can function as a template against which other listings can be compared to determine if a listing associated with the first listing has information that can allow a buyer to make an informed decision. In particular, the listing framework can correspond to a template for information that can accompany a listing along with how the information can be presented in a listing. If a listing associated with the first item does not include the information that can allow a buyer to make an informed decision based on the framework, the listing can be augmented to include the additional information. Moreover, if listings having the listing framework that is presented in the manner shown in the listing framework have a high success rate of selling, the listing can be augmented to mimic the manner shown in the listing framework.

The vector representations can represent a semantic space. When the multimodal large language learning model extracts readable text from the image content, the multimodal large language learning model can transcode the extracted readable text into vector representations. Using the vector representations, the multimodal large language learning model can search the corpus of categories for second items having similar vector representations. When a second item is found having vector representations similar to the vector representations associated with the human readable text associated with the first item, the machine learning model can use the framework associated with the second listing to determine which of the human readable text should be emphasized in the first listing and augment the first listing accordingly.

### BRIEF DESCRIPTION OF THE DRAWINGS

Various ones of the appended drawings merely illustrate examples of the present disclosure and should not be considered as limiting its scope.

FIG. 1 is a network diagram illustrating a network environment suitable for augmenting an item listing, according to some examples.

FIG. 2 shows a category corpus of FIG. 1 and image contents and vector representations stored at the category corpus, according to some examples.

FIG. 3 illustrates a method for augmenting a first listing for an item using components of FIG. 1, according to some examples.

FIG. 4 illustrates an item image content having a listing, according to some examples.

FIG. 5 shows a listing associated with a vector representation found using the method of FIG. 3, according to some examples.

FIG. 6 is an augmented listing associated with an item of the item image content of FIG. 4, according to some examples.

FIG. 7 shows item information for an item of the item image content of FIG. 4, according to some examples.

FIG. 8 illustrates indicators that can be extracted from an image content by a multimodal large language learning model and converted to human readable text to create an item of the item image content of FIG. 4, according to some examples.

FIG. 9 is a block diagram illustrating architecture of software used to implement social network-initiated listings, according to some examples.

FIG. 10 is a block diagram illustrating a machine as an example computer system with instructions to cause the machine to implement social network-initiated listings, according to some examples.

FIG. 11 is a block diagram illustrating an machine learning pipeline, according to some example embodiments.

FIG. 12 is a data flow diagram illustrating training and use of a machine learning program, according to some example embodiments.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

Examples relate to a system and method that use a multimodal large language learning model to extract readable text from an image content and transpose the readable text into human-readable text. The image content can relate to a first item and the system can augment a first listing associated with the item with the human-readable text. The system can transpose the human-readable text into a first type and a second type different from the first type, such as a first language and a second language that is different from the first language.

The system can include a corpus of categories (also referred to herein as a “category corpus”) transcoded into vector representations. The corpus of categories can correspond to second items having characteristics that are similar to characteristics of the first item. The second items can also be associated with second listings. The second listings can comprise framework that can be used to augment the first listing. The framework can function as a template against which other listings can be compared to determine if a listing associated with the first listing has information that can allow a buyer to make an informed decision. In particular, the listing framework can correspond to a template for information that can accompany a listing along with how the information can be presented in a listing. If a listing associated with the first item does not include the information that can allow a buyer to make an informed decision based on the framework, the listing can be augmented to include the additional information. Moreover, if listings having the listing framework that is presented in the manner shown in the listing framework have a high success rate of selling, the listing can be augmented to mimic the manner shown in the listing framework.

The vector representations can represent a semantic space. When the multimodal large language learning model extracts readable text from the image content, the multimodal large language learning model can transcode the extracted readable text into vector representations. Using the vector representations, the multimodal large language learning model can search the corpus of categories for second items having similar vector representations. When a second item is found having vector representations similar to the vector representations associated with the human-readable text associated with the first item, the machine learning model can use the framework associated with the second listing to determine which of the human-readable text should be emphasized in the first listing and augment the first listing accordingly.

The vector representations can represent a semantic space. When the multimodal large language learning model extracts readable text from the image content, the multimodal large language learning model can transcode the extracted readable text into vector representations. Using the readable text vector representations, the multimodal large language learning model can search the corpus of categories for second items having similar vector representations by using a first characteristic associated with the first vector representation and a second characteristic associated with the second vector representation. When a second item is found having vector representations similar to the vector representations associated with the human-readable text associated with the first item, the multimodal large language learning model can use the framework associated with the second listing to determine which of the human-readable text should be emphasized in the first listing. The multimodal large language learning model can also adapt the process described above for an audio component. Thus, if the multimodal large language learning model receives a video, the multimodal large language learning model can extract audio components from the video and proceed to determine a framework to use based on vector representations, as discussed above.

As an example, a user may be selling a 2024 Genetian Blue Porsche™ 911™ GTS having a PDK™ transmission. A user may be capturing video of the Porsche™ and narrating the video while walking around the Porsche™ and capturing the video. While capturing the video, the user may open the bonnet to show the engine while the Porsche™ is idling. During the narration, the user may indicate that the is a blue 2024 Porsche™. The user may also capture an interior view of the Porsche™.

While creating a listing for the vehicle, the seller notes that the vehicle is a 2024 Porsche™ 911™, lists the engine as being a 3.0 liter V-6 that outputs close to 500 horsepower. The user may also note that the color is blue, has 2,000 miles, and has power seats. In accordance with examples, a multimodal large language learning model can be fed the video and extract the following features from the video, the script on the bonnet having the letters “GTS,” the lack of a manual transmission shifter, and the color blue. In addition, the multimodal large language learning model can extract from the narration that the vehicle is a 2024 Porsche™. The multimodal large language learning model can extract these features in the form of first vector representations.

Using the first vector representations, the multimodal large language learning model can then access a category corpus and search for vector representations that correlate to “2024,” “Porsche™ 911™,” “blue,” “GTS,” and “3.0 liter V-6.” The multimodal large language learning model can find second vector representations corresponding to the first vector representations and then access listings associated with the second vector representations.

Here, the multimodal large language learning model can find ten previous listing for a blue 2024 Porsche™ 911™ GTS and align various features from the ten previous listings with the listing created by the seller. Of the ten listings, the multimodal large language learning model can determine seven of the listings indicated that the transmission type of the vehicle as either manual or being a PDK™. The multimodal large language learning model can also note that all seven listings resulted in a sale. Additionally, the multimodal large language learning model can determine that five listings for blue 2024 Porsche™ 911™ GTSs noted the color as being Genetian blue. In examples, the multimodal large language learning model can also access external sources and determine that for model year 2024, all blue Porsche™ 911™ GTS were Genetian blue. In addition, the multimodal large language learning model can note that all of the listings indicated that the engine for a 2024 Porsche™ 911™ GTS was 3.0 liter flat six and six noted that the engine outputted 473 horsepower.

Based on all having transmission information, the multimodal large language learning model can augment the listing to include a PDK™ transmission and indicate that the 2024 Porsche™ 911™ is a GTS. The multimodal large language learning model can augment the listing with this information since the multimodal large language learning model was able to perform image content extraction from the video. The multimodal large language learning model can also augment the listing to indicate that the engine is a 3.0 liter flat six outputting 473 horsepower. Furthermore, the language learning model can augment the listing to indicate that the color is Genetian blue. The multimodal large language learning model can augment the listing by determining that a majority of the listings included this information. The multimodal large language learning model can then present the augmented listing to the seller.

Examples improve the functioning of a computing device. A computing device can be configured, via a trained multimodal large language learning model, to extract image content data from an image content and convert the image content data to vector representations. Using the extracted vector representations, a computing device can search for matching vector representations that are similar to the extracted vector representations. The matching vector representations can be associated with frameworks that can be used to determine how data should be output from the computing device.

Besides improving the functioning of a computing device in relation to an image content, examples improve the functioning of a computing device in relation to a video. More specifically, a computing device can be configured, via a trained multimodal large language learning model, to extract image content data and audio data from a video and convert the image content data to image content vector representations and convert the audio data to audio vector representations. Using the extracted image content and audio vector representations, a computing device can search for matching image content and audio vector representations that are similar to the extracted image content and audio vector representations. The matching image content and audio vector representations can be associated with frameworks that can be used to determine how data should be output from the computing device.

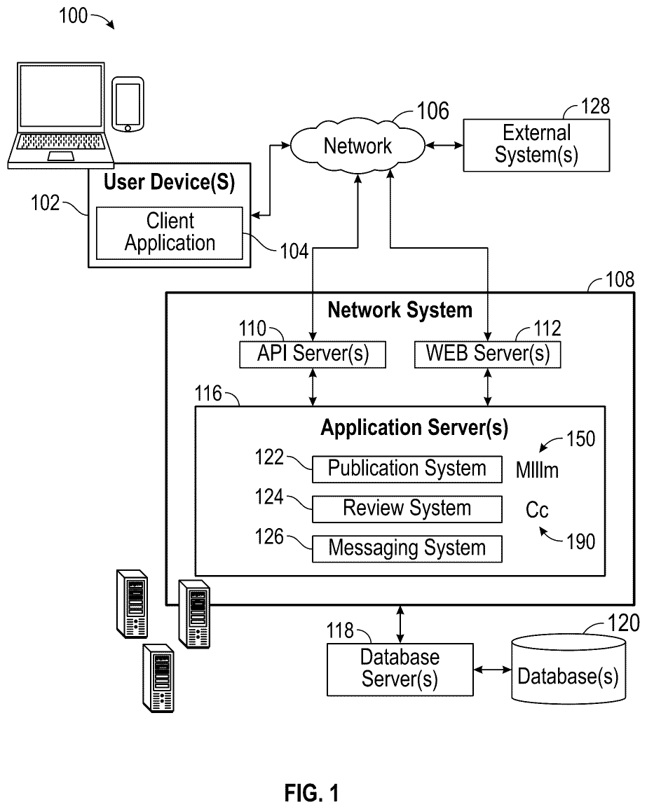

Now turning attention to the Figures and more specifically FIG. 1, FIG. 1 is a block diagram showing an example network environment 100 that includes a messaging system 126, according to various examples of the present disclosure. As shown, the network environment 100 includes one or more user devices 102, a network system 108, and a network 106 (e.g., Internet, wide-area-network (WAN), local-area-network (LAN), wireless network) that communicatively couples them together. Each user device 102 can host a number of applications, including a client software application 104. The client software application 104 can communicate and exchange data with the network system 108 via a network 106.

A user device 102 may comprise but is not limited to, a smartphone, tablet, laptop, multi-processor systems, microprocessor-based or programmable consumer electronics, game consoles, or any other communication device that can access the network system 108. Additionally, each user device 102 comprises a display component (not shown) to display information (e.g., in the form of user interfaces) as will be discussed in more detail below.

The network system 108 provides server-side functionality via the network 106 to the client software application 104. While certain functionality is described herein as being performed by the messaging system 126 on the server system 108, it will be appreciated that the location of certain functionality within the network system 108 is a design choice. For example, it may be technically preferable to initially deploy certain technology and functionality within the network system 108, but to later migrate this technology and functionality to the client software application 104.

The network system 108 supports various services and operations that are provided to the client software application 104 by a publication system 122, a review system 124, and the messaging system 126. The various services and operations provided by publication system 122, a review system 124, and the messaging system 126 can relate to transmitting data from any one or more of the publication system 122, the review system 124, and the messaging system 126 to the client software application 104; receiving data from the client software application 104 at any one or more of the publication system 122, the review system 124, and the messaging system 126; and processing data generated by the client software application 104. Data exchanges within the network environment 100 may be invoked and controlled through operations of software component environments available via one or more endpoints, or functions available via one or more user interfaces of the client software application 104, which may include web-based user interfaces provided by the server system 108 for presentation at the user device 102.

With respect to the network system 108, one or more application programing interface (API) servers 110 and one or more web servers 112 are coupled to and provide programmatic and web interfaces respectively to one or more application servers 116. The application server(s) 116 host various systems including the publication system 122, the review system 124, and the messaging system 126, each of which comprises a plurality of components and each of which can be embodied as hardware, software, firmware, or any combination thereof. The application server(s) 116 are, in turn, coupled to one or more database servers 118 that facilitate access to one or more database(s) 120. The database(s) 120 may be stored in one or more storage devices and may, for example, include user accounts including user profiles of users of the network system 108 and can also store chat histories between users utilizing functionality of the messaging system 126.

The API server(s) 110 receives and transmits data (e.g., API calls, commands, requests, responses, and authentication data) between the user device(s) 102 and the application server 116. Specifically, the API server(s) 110 provides a set of interfaces (e.g., routines and protocols) that can be called or queried by the client software application 104 in order to invoke the functionality of the application server(s) 116. The API server(s) 110 expose various functions supported by the application server 116 including, without limitation, messaging, listing publication, and review of goods and services and sellers thereof.

The publication system 122 manages publications (e.g., articles, listings of available goods or services) and transactions (e.g., for goods and services) at the network system 108 including generating and publishing the publications, conducting searches for publications, and/or maintaining user accounts.

The review system 124 allows users to provide feedback on goods and services as well as the sellers of goods and services. Utilizing the review system 124, users can rate goods, services, and sellers thereof on various aspects such as quality, shipping speed, and customer service, providing a comprehensive evaluation. The review system 124 may aggregate and analyze review data to present summary statistics and trends to users. The messaging system 126 facilitates electronic chat conversations between users by allowing them to exchange messages that include text, audio, image contents, and/or videos.

The environment 100 can also comprise one or more external systems 128. The external system(s) 128 can be a third-party system that performs data operations or processing for the network system 108. For example, the external system(s) 128 can comprise a large language model (LLM) or generative artificial intelligence (AI) system that processes data on behalf of the network system 108. The LLM is a trained model configured to generate text and perform natural language processing tasks such as classifying an intent of messages.

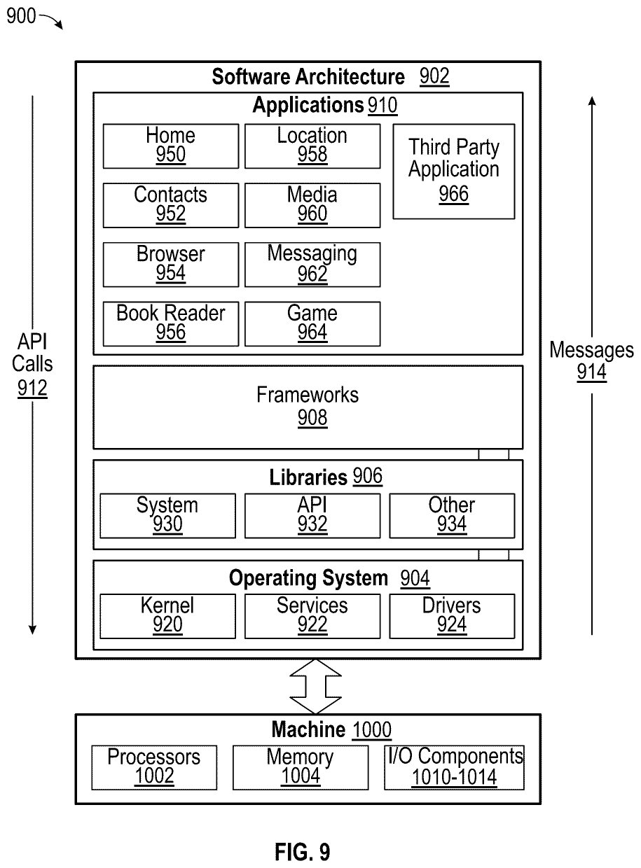

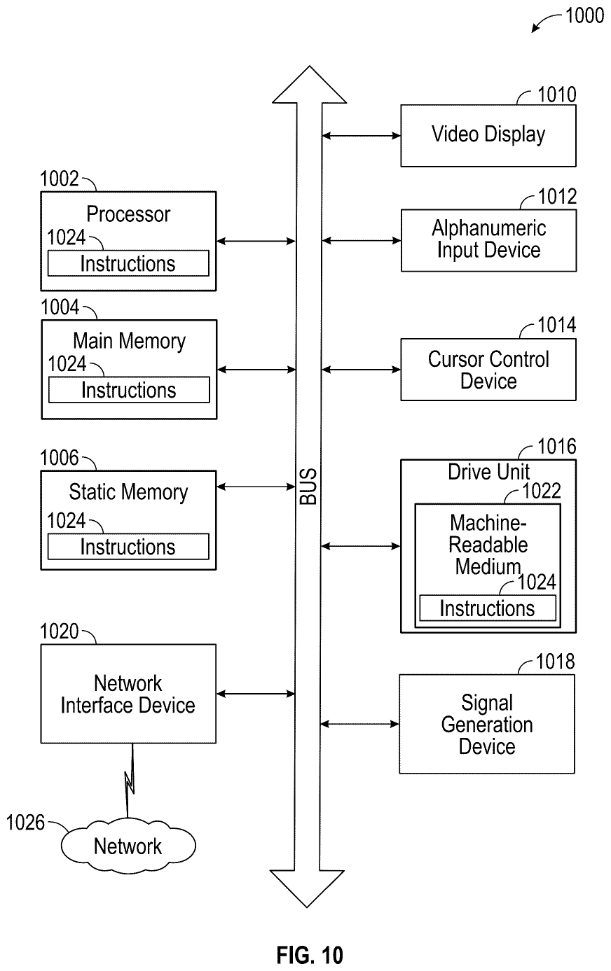

Any of the systems, data storage, or devices (collectively referred to as “components”) shown in, or associated with, FIG. 1 may be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIGS. 9 and 10, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Functionalities of one system may, in alternative examples, be embodied in a different system. For example, any of the functionalities discusses above with respect to the messaging system 126 may be embodied within the user device 102, the publication system 122, or the review system 124. While only a single network system 108 is shown, alternatively, more than one network system 108 can be included (e.g., localized to a particular region). The application server 116 can also include a multimodal large language learning model 150.

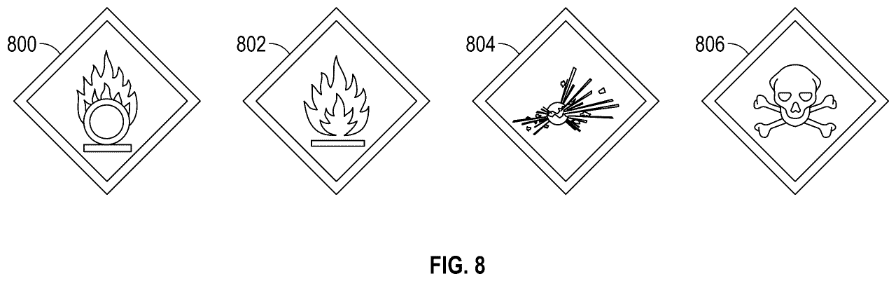

As noted above, examples relate to a system and method that uses the multimodal large language learning model (MLLLM) 150 to extract readable text from an item image content and transpose the readable text into human readable text. The multimodal large language learning model 150 can be trained to extract text from an item image content and identify indicators at an item image content. As will be discussed further below, such as with reference to FIG. 8, an indicator at item image content can relate to content that can graphically provide information. In some instances, the indicator can be an indicator image. For example, an indicator can relate to a hazardous symbol per the GHS of Classification and Labelling of Chemicals or any other type of classification system, which would be an indicator image. The multimodal language learning model 150 can be configured to convert the meaning of the indicator to indicator text that corresponds to a meaning of the indicator. Thus, if the indicator relates to a hazardous symbol, such as a corrosive material, the multimodal language learning model 150 can provide human readable text, which can be indicator text, that indicates the item has corrosive material. The multimodal large language learning model 150 can then augment a listing associated with the item image content.

The multimodal large language learning model 150 can use key frame detection techniques for video recognition. The multimodal large language learning model 150 can include a visual learning model (VLM) that can discern visual differences between a first image content and a second image content. Via a visual learning model, the multimodal large language learning model 150 can be used to indicate to a user any differences between a first image content and a second image content. It should be noted that any discussion in reference to a multimodal large language learning model can also refer to a visual learning model. Thus, aspects related to training a multimodal large language learning model can also apply to a visual learning model.

A visual learning model can process and understand both visual information, which can include image contents and/or videos, and textual information simultaneously. Visual learning models can couple computer vision processing capabilities with natural language processing capabilities. Thus, visual learning models can perform tasks that require understanding the relationships between visual and linguistic elements.

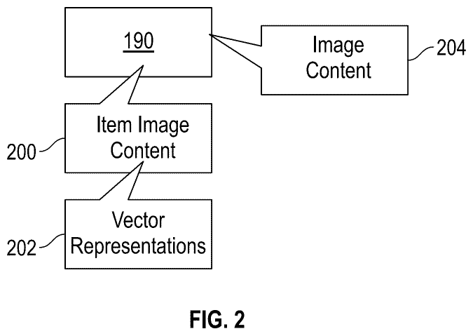

The multimodal large language learning model 150 can be trained on a category corpus (CC) 190. The category corpus 190 can include both text data and image content data. The category corpus 190 can include item image contents 200 that are associated with items that were previously sold or are currently for sale and are therefore associated with listings, as shown with reference to FIG. 2. Vector representations 202 associated with the item image contents 200 can also be stored at the category corpus 190. The category corpus 190 can also have a listing framework 204 that can include types of listing information that can accompany a listing. The listing framework 204 can be derived from the item image contents 200 and the vector representations 202.

The vector representations 202 can capture and quantify semantic content. Semantic content can relate to inherent meanings that are conveyed by linguistic expressions. The vector representations 202 can encode the semantic content, which can include words and phrases, in a high dimensional space. The semantic content can relate to information that accompanies the item image contents 200.

The item image contents 200 can relate to items that have been previously sold and the semantic content can relate to information that accompanied a listing associated with the items when they were listed for sale. The information can describe various aspects of the items that were sold, such as ingredients, color, uses for the item, or any other type of information that can accompany any item that is for sale or has been sold. This information can be used to create the listing framework 204. Thus, when similar items are listed for sale, examples can use the listing framework 204 to augment a listing for the similar items.

The listing framework 204 can function as a template where the template can represent what types of information should be included with a listing and how the information should be presented with the listing. Moreover, the listing framework 204 can show how listing information was presented in a listing for various items where sellers successfully sold the various items. Thus, if the similar items do not include a color or a use for the item, which can be specified by the framework 204, this information can be added to the listing by augmenting the listing, as will be discussed further on. This can avoid the problem discussed above where a seller of an item does not provide relevant information for an item that the seller has posted for sale.

The category corpus 190 can be created by receiving the item image contents 200 and extracting the vector representations 202 from the item image contents 200. Using the vector representations 202 along with semantic content extracted from the vector representations 202, the listing framework 204 can be generated. These processes can be performed as a background process and prior to augmenting listings as described herein.

The multimodal large language learning model 150 can employ visual processing along with text extraction to extract readable text from an item image content. An image content encoder of the multimodal large language learning model 150 can use Convolutional Neural Networks (CNNs) to extract data from an item image content. CNNs can use convolutional layers to detect visual patterns and pool layers to reduce spatial dimensions. CNNs can also flatten layers to convert two-dimensional outputs to one dimensional vectors, such as vector representations. The multimodal large language learning model 150 can also use vison transformers to process image content information. Moreover, visual processing can be used to detect distortions in an item image content.

The multimodal large language learning model 150 can also be trained to extract audio in a video and transpose the audio into human readable text. The multimodal large language learning model 150 can use automatic speech recognition. The multimodal large language learning model 150 can include acoustic models, language models, and a decoder, which can be used to convert audio components into human readable text. Using these features, the multimodal large language learning model 150 can convert audio into a spectrogram or similar features that can represent the speech signal. The multimodal large language learning model 150 can also break down the audio into phonemes and combine the phonemes to form words and sentences, such as human readable text.

The multimodal large language learning model 150 can also employ Optical Character Recognition where the text extracted from an item image content can be fed to the multimodal large language learning model 150. The multimodal large language learning model 150 can also use end-to-end learning to directly recognize and process text within an item image content. Moreover, the multimodal large language learning model 150 can use visual-textual alignment where contrastive learning can be used to align visual and textual features in a shared embedding space. By aligning visual and textual features, the multimodal large language learning model 150 can associate regions of an item image content with textual concepts. The text extracted from an item image content can be used to augment a listing for an item associated with the item image content.

Prompt engineering can be used to train the multimodal large language learning model 150 to produce information that can be used to augment listings. The provided prompts can convey meaning and context that can enable the multimodal large language learning model to create relevant and reliable information to be used to augment listing. Shot prompting can be used with transformer-based models, such as GPT-4 incorporated by multimodal large language learning models, to guide the multimodal large language learning model's output using a given number of examples or prompts, which can be referred to as shots.

Zero, one, or few shot prompting can be used while training the multimodal large language learning model 150. In zero-shot prompting, instead of providing the multimodal large language learning model 150 with examples and/or demonstrations, the multimodal large language learning model 150 can rely on the pre-trained knowledge of the multimodal large language learning model. In one-shot prompting, one example can be given before completing the request. A specialized prompt during one-shot prompting that can be designed for vector representation extraction can be provided. In few shot prompting, multiple examples can be given before completing the request. Similar to one shot promoting, specialized prompts can be designed for vector representation extraction.

The multimodal large language learning model 150 can be trained to focus on various features in an image content. In the 2024 Porsche™ 911™ GTS example above, the multimodal large language learning model 150 can be trained to focus on the interior of the vehicle and specifically the center console to determine if the vehicle has a PDK™ transmission or a manual transmission. This can training be done for a variety of reasons, such as if buyers for the item tend to place particular importance on vehicle interiors or a vehicle transmission type. While vehicles are given as an example, this can be applied to any type of item where buyers typically place emphasis on a particular attribute and less emphasis on other attributes.

Similarly, the multimodal large language learning model 150 can be trained to determine what aspects have received the most video and/or audio attention in order to determine what information should be used to augment an item listing. In the 2024 Porsche™ 911™ GTS example above, if the seller spends a lot of time showing the motor, the multimodal large language learning model 150 can be trained to determine that augmenting should include additional information relating to the motor. Likewise, if the seller spends a majority of the time talking about modifications done to the 2024 Porsche™ 911™ GTS, such as front and rear spoilers and suspension upgrades, the multimodal large language learning model 150 can be trained to determine that augmenting should include additional information relating to spoilers and suspension upgrades.

During training, the multimodal large language learning model 150 can also be trained using Retrieval Augmented Generation (RAG). RAG can incorporate an indexing stage, a retrieval stage, an augmentation stage, and a generation stage. By implementing RAG, the multimodal large language learning model 150 can access and use current information that is outside the training data provided during training to assist in determining if a listing for an item should be augmented and how the listing should be augmented.

For example, the multimodal large language learning model 150 can access external sources to determine any additional listing information that should accompany a listing. This can include identifying indicator image contents, such as hazardous symbols per the Globally Harmonized System (GHS) of Classification and Labelling of Chemicals, on an image content and then converting the meaning of the indicator image contents to indicator text, which can be human readable text. The multimodal large language learning model 150 can then generate listing information per the framework 204 and augment a listing with the indicator text.

Direct Preference Optimization (DPO) can also be used during training of the multimodal large language learning model 150. The multimodal large language learning model 150 can be trained align output with human preferences using DPO. Using DPO to train the multimodal large language learning model 150 can allow the multimodal large language learning model 150 to provide an output, such as additional information for a listing associated with an item and augmenting a listing associated with an item, such that the output can more closely match human expectations.

The training discussed above can be done using a first set of training data at a first time period. After the multimodal large language learning model 150 is trained with the first training data during the first time period, augmented listings can be monitored to determine an accuracy level of the information used to augment the listing. The accuracy level can be determined by comparing the augmented listing to the listing framework 204 along with the listing information that accompanied the item image contents 200.

If the accuracy level is below an accuracy threshold, the multimodal large language learning model 150 can be trained with second training data at a second time period subsequent to the first time period using the techniques described above in order to change the multimodal large language learning model 150. Output in the form of augmented listings from the changed multimodal large language learning model 150 that has been trained with the second training data at the second time period can be compared as described above to determine if the accuracy level is above or below the accuracy threshold. If the accuracy level is above the accuracy threshold, the changed multimodal large language learning model 150 can be used to augment further listings. If not, training can be performed with third training data at third time period. Moreover, the accuracy level can be continually monitored and the multimodal large language learning model 150 can be continually retrained based on the accuracy level of the multimodal large language learning model 150 in order to enhance the augmenting of listings associated with items.

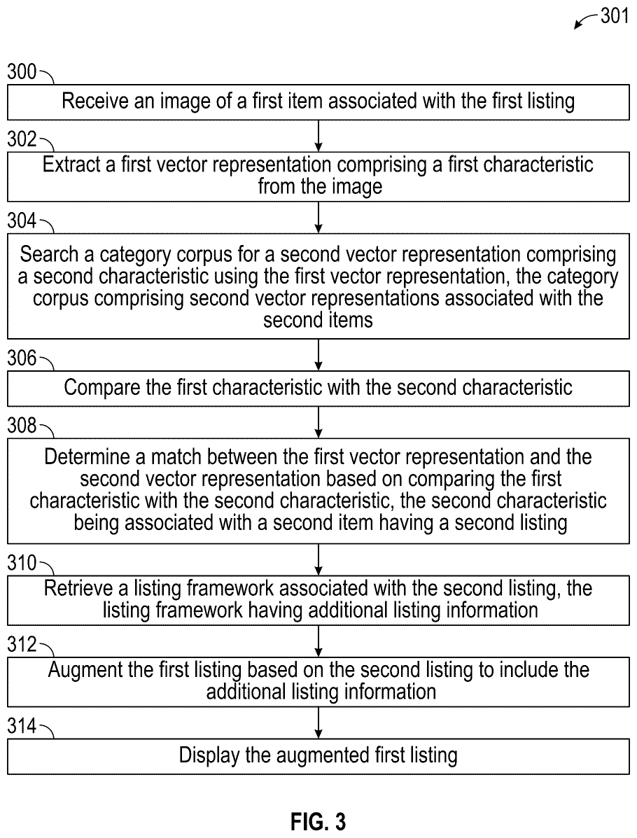

Now making reference to FIG. 3, a method 301 for augmenting a first listing for an item is shown. It will be understood that example methods described herein may be performed by a machine in accordance with some examples. For example, the method 301 can be performed by the application server 116 described with respect to FIG. 1, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 301 may be represented by executable instructions that, when executed by a processor of a computing device, cause the computing device to perform method 301. Accordingly, the operations of the method 301 are described below in reference to such a computing device.

Depending on the embodiment, an operation of an example method described herein may be repeated in different ways or involve intervening operations not shown. Though the operations of example methods may be depicted and described in a certain order, the order in which the operations are performed may vary among examples, including performing certain operations in parallel.

At operation 300, image content of a first item associated with the first listing is received. The image content can be received at the application server 116 and in particular at the multimodal large language learning model 150. The image content can relate to an item that a first user is attempting to sell. The image content can be received in the form of a video that includes an audio component, such as the instance described above where a user is recording a video of an item and providing narration during capture of the video.

At operation 302, the multimodal large language learning model 150 can extract a first vector representation having a first characteristic from the image content as described above. The first vector representation can relate to a video characteristic in a semantic space or an audio characteristic in a semantic space.

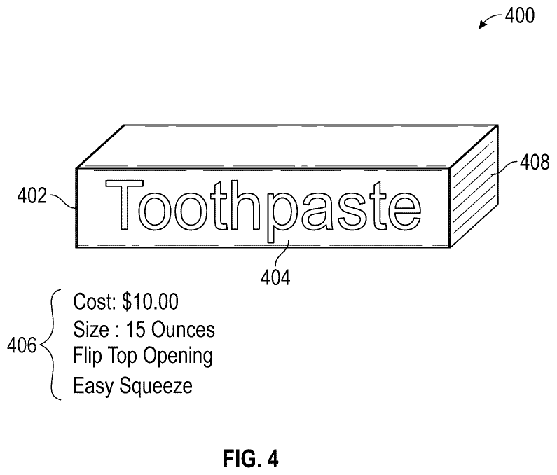

To further describe the method 301 and referred to herein as “the example,” reference is made to FIG. 4 and item image content 400. During the operation 300, the multimodal large language learning model 150 receives the item image content 400 of a first item 402. In the example presented by FIG. 4, a seller is posting a listing for the first item 402. The multimodal large language learning model 150 extracts a first vector representation 404 from the item image content 400 during the operation 302. The first vector representation can comprise a first characteristic in the form of the terms “tooth” and “paste.” In addition, during the operation 300, the multimodal large language learning model 150 reads a first listing 406 along with item data 408 from the item image content 400. The multimodal large language learning model 150 can use any of the visual processing techniques described above to read the first listing 406 and the item data 408.

Returning to FIG. 3, after extracting a first vector, the method 301 searches a category corpus for a second vector representation that has a second characteristic using the first characteristic during an operation 304. As discussed above, a category corpus can include a plurality of vector representations that are associated with second items.

The first and second characteristics can relate to an aspect of items from which the first and second vector representations have been extracted. The characteristics can be a color of the items from which the first and second vector representations have been extracted, a type of the items from which the first and second vector representations have been extracted, such as a vehicle, an appliance, an electronic device, a consumer good, or any other type of item.

During the search of the category corpus, the first characteristic is compared with the second characteristics of the second vector representations, at operation 306. A match can be determined between the first vector representation and the second vector representation based on comparing the first characteristic with the second characteristic, at operation 308. The second characteristic can be associated with a second item having a second listing. Multiple matches can be found, where the first characteristic can be a type such as a vehicle. Furthermore, multiple vehicles, which accompany a match, can be found during the operation 304 and multiple comparisons can be performed during the operation 306 based on the multiple vehicles being found.

When a match is found between a first vector representation and a second vector representation, a listing framework associated with the second listing can be retrieved from the category corpus 190, at operation 310. In instances when multiple matches are determined at the operation 308, multiple listing frameworks are retrieved. As noted above, the listing framework can serve as a template for information that can be provided with a listing. The listing framework shows how information was presented in a listing that achieved a greater amount of success. During the operation 310, additional listing information that can accompany a listing is determined from the listing framework. In addition, during the operation 310, the multimodal large language learning model 150 accesses external sources as discussed above to determine the additional listing information based on the listing framework if the additional information is not discernable from the image content received during the operation 300.

Once the listing framework is located, the multimodal large language learning model 150 uses the listing framework to determine if the first listing should be augmented with additional listing information. If the multimodal large language learning model 150 determines that the first listing should be augmented with additional listing information, the multimodal large language learning model 150 determines how the first listing should be augmented. For example, if the first listing does not include a format that is similar to the listing framework where the format can correspond to the additional listing information, the multimodal large language learning model 150 determines to augment the first listing such that the first listing has a format that is similar to the listing framework.

As a further example, if the multimodal large language learning model 150 determines that the first listing is missing a type of information based on information in the listing framework, the multimodal large language learning model 150 augments the first listing to include the type of information. The multimodal large language learning model 150 augments the first listing based on the second listing and the listing framework to include the additional listing information during an operation 312. The multimodal large language learning model 150 causes the augmented first listing to be displayed on a display device, at operation 314.

Turning attention back to the example and FIG. 4, during the operation 306, the multimodal large language learning model 150 searches the vector representations 202 at the category corpus 190 using the first vector representation 404 having the first characteristic “tooth” and “paste.” In the example, the method 301 of FIG. 3 determines that there are ten item listings having a second characteristic “tooth” and “paste,” ten item listings having the second characteristic “tooth” and “pick,” and five item listings having the second characteristic “mouth” and “paste.” The method 301 can make this determination based on the second vector representations that have been found.

During the operation 306, the first characteristic “tooth” and “paste” is compared with the second characteristics “tooth” and “paste,” “tooth” and “pick,” and “mouth” and “paste.” During the operation 308, a determination by the method 301 can be made that the second characteristic “tooth” and “paste” matches the first characteristic “tooth” and “paste.” Thus, the listing frameworks 204 associated with the second listings for the vector representations having the second characteristics “tooth” and “paste” are retrieved from the category corpus 190 during the operation 310.

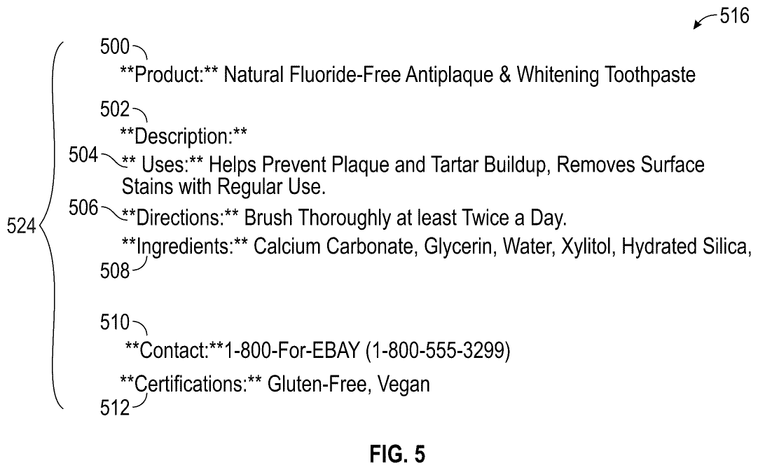

At operation 312, which, for purposes of the example, reference will now be made to FIG. 5 to further describe the example, a determination is made that the second listings include additional information 500-512 in a listing framework 514 that can be a template, as shown with reference to FIG. 5 and a second listing 516. In the example, the additional information 500 can relate to a product (referred to herein as product 500), the additional information 502 can relate to a description (referred to herein as description 502), the additional information 504 can relate to uses (referred to herein as uses 504), and the additional information 506 can relate to directions (referred to herein as directions 506). Furthermore, the additional information 508 can relate to ingredients (referred to herein as ingredients 508), the additional information 510 can relate to a contact (referred to herein as contact 510), and the additional information 512 can relate to certifications (referred to herein as certifications 512).

At the operation 312, the multimodal large language learning model 150 determines that the first listing 406 does not include the product 500, the description 502, and the directions 506. Additionally, the multimodal large language learning model 150 determines that the first listing 406 does not include the ingredients 508, the contact 510, and the certifications 512. Accordingly, the multimodal large language learning model 150 determines that the first listing 406 should be augmented during the operation 312.

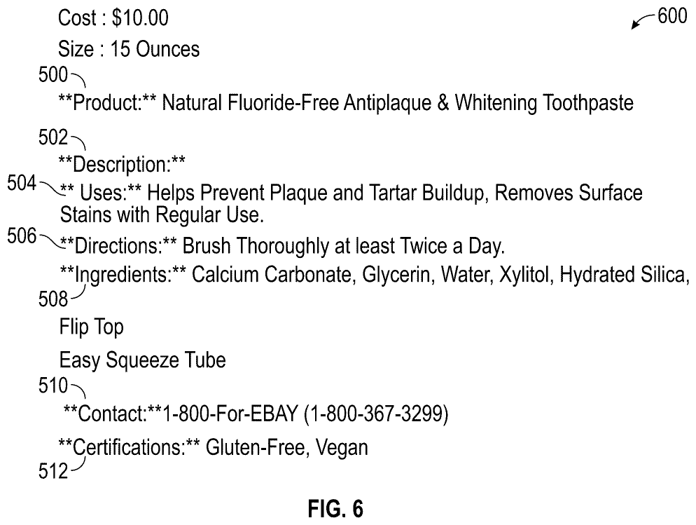

In the example, the multimodal large language learning model 150 augments the first listing 406 to include the product 500, the description 502, and the directions 506 to create an augmented listing 600 as shown at FIG. 6 during the operation 312. Moreover, the multimodal large language learning model 150 augments the first listing 406 to have the ingredients 508, the contact 510, and the certifications 512, as shown at FIG. 6 and the augmented listing 600.

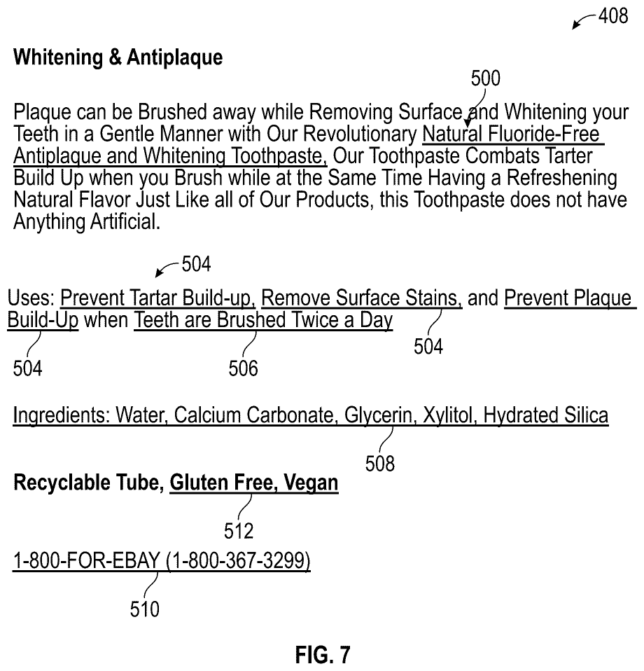

As noted above, during the operation 300, the multimodal large language learning model 150 reads the item data 408. Furthermore, as discussed above, the multimodal large language learning model 150 can be trained to provide an output that matches human expectations. Thus, during the operation 312, the multimodal large language learning model 150 can read the text of the product 500, the directions 506, the ingredients 508, the contact 510, and the certifications 512 from the item data 408, an example of which is illustrated by FIG. 7, during the operation 312. Furthermore, using DPO, the multimodal large language learning model 150 can create the augmented listing 600 with the additional information read from the item data 408. In particular, multimodal large language learning model 150 can rearrange the additional information 500 as it was presented in the item image content 400 in a first sequence such that the additional information will be displayed in a second sequence in the augmented listing 600.

After the multimodal large language learning model 150 creates the augmented listing 600, the multimodal large language learning model 150 can cause the display of the augmented listing 600 to the seller, such as causing the augmented listing 600 to be displayed on the device 130. Moreover, the user 180 can then decide to accept the augmented listing 600, decline the augmented listing 600, or modify the augmented listing 600.

While the example is discussed with reference to an image content component, the operations 300-312 can also be applied to audio components in order to augment a first listing.

As discussed above, the multimodal large language learning model 150 can access external sources to determine any additional listing information that should accompany a listing. This can include identifying indicator image contents, which can be an indicator, such as hazardous symbols per the GHS of Classification and Labelling of Chemicals, on an image content and then converting the meaning of the indicators to indicator text, which can be human readable text.

Now making reference to FIG. 8, examples of indicator image contents, which, for discussion purposes, relate to GHS pictograms, can be included with an image content associated with an item listing. In FIG. 8, image contents associated with item listings can include indicators, such as indicators 800-806, that can relate to hazards that may be associated with an item of the item listing. For example, the indicator 800 can show that an item associated with item listing can cause or contribute to combustion without an ignition source. The indicator 802 can show that an item associated with item listing can catch fire and burn easily. The indicator 804 can show that an item associated with the item listing can have chemical substances or mixtures that are explosive. Moreover, the indicator 806 can show that an item associated with the item listing can be severely toxic.

After the multimodal large language learning model 150 recognizes an indicator, such as the indicators 800-806, the multimodal large language learning model 150 can convert the meaning of the indicator into human-readable text and generate listing information based on the human-readable text. In addition, the multimodal large language learning model 150 can augment the first listing 406 with this listing information.

The multimodal large language learning model 150 can also be configured to convert the human-readable text into a given language based on a location of where the augmented listing will be displayed. Thus, if the augmented listing will be displayed in a region speaking Tamil, the multimodal large language learning model 150 can convert the augmented listing to Tamil from English, where English can be a first format and Tamil can be second format. Moreover, for instances where a listing is being augmented with indicator text, the location can be used to convert the indicator text from a first format to a second format, where the first format can be English and the second format can be Tamil. In both of these instances, the listing can be augmented in Tamil.

FIG. 9 is a block diagram 800 illustrating a software architecture 802, which may be installed on any one or more of the devices described above. FIG. 8 is merely a non-limiting example of a software architecture, and it will be appreciated that many other architectures may be implemented to facilitate the functionality described herein. The software architecture 802 may be implemented by hardware such as a computer system 1000 of FIG. 10 that includes a processor 1002, memory 1004 and 1006, and I/O components 1010-1014. In this example, the software architecture 802 may be conceptualized as a stack of layers where each layer may provide a particular functionality. For example, the software architecture 802 includes layers such as an operating system 904, libraries 906, frameworks 1208, and applications 910. Operationally, the applications 910 invoke application programming interface (API) calls 912 through the software stack and receive messages 914 in response to the API calls 912, according to some implementations.

In various implementations, the operating system 904 manages hardware resources and provides common services. The operating system 904 includes, for example, a kernel 920, services 922, and drivers 924. The kernel 920 acts as an abstraction layer between the hardware and the other software layers in some implementations. For example, the kernel 920 provides memory management, processor management (e.g., scheduling), component management, networking, and security settings, among other functionality. The services 922 may provide other common services for the other software layers. The drivers 924 may be responsible for controlling or interfacing with the underlying hardware. For instance, the drivers 924 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 906 provide a low-level common infrastructure that may be utilized by the applications 910. The libraries 906 may include system libraries 930 (e.g., C standard library) that may provide functions such as memory allocation functions, string manipulation functions, mathematic functions, and the like. In addition, the libraries 06 may include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 906 may also include a wide variety of other libraries 934 to provide many other APIs to the applications 910.

The frameworks 908 provide a high-level common infrastructure that may be utilized by the applications 910, according to some implementations. For example, the frameworks 908 provide various graphic user interface (GUI) functions, high-level resource management, high-level location services, and so forth. The frameworks 908 may provide a broad spectrum of other APIs that may be utilized by the applications 910, some of which may be specific to a particular operating system or platform.

In an example, the applications 910 include a home application 950, a contacts application 952, a browser application 954, a book reader application 956, a location application 958, a media application 960, a messaging application 962, a game application 964, and a broad assortment of other applications such as a third-party application 966. According to some examples, the applications 910 are programs that execute functions defined in the programs. Various programming languages may be employed to create one or more of the applications 910, structured in a variety of manners, such as object-orientated programming languages (e.g., Objective-C, Java, or C++) or procedural programming languages (e.g., C or assembly language). In a specific example, the third-party application 966 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 966 may invoke the API calls 912 provided by the mobile operating system (e.g., the operating system 904) to facilitate functionality described herein.

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client or server computer system) or one or more processors may be configured by software (e.g., an application or application portion) as a hardware-implemented module that operates to perform certain operations as described herein.

In various examples, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering examples in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, include processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some examples, the processor or processors may be located in a single location (e.g., within a home environment, an office environment or as a server farm), while in other examples, the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via the network 106 (e.g., the Internet) and via one or more appropriate interfaces (e.g., application program interfaces (APIs).)

Examples may be implemented in digital electronic circuitry, or in computer hardware, firmware, software, or in combinations of them. Examples may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers, at one site or distributed across multiple sites, and interconnected by a communication network.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various examples.

FIG. 9 is a block diagram of a machine within which instructions may be executed for causing the machine to perform any one or more of the methodologies discussed herein. In one example, the machine may be any of the devices described above. In alternative examples, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that, individually or jointly, execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device (cursor control device) 1014 (e.g., a mouse), a disk drive unit 1016, a signal generation device 1018 (e.g., a speaker) and a network interface device 1020.

The drive unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media. Instructions 1024 may also reside within the static memory 1006.

While the machine-readable medium 1022 is shown in an example to be a single medium, the term “machine-readable medium” may include a single medium or multiple media (e.g., a centralized or distributed database, and/or associated caches and servers) that store the one or more instructions or data instructions 1024. The term “machine-readable medium” shall also be taken to include any tangible medium that is capable of storing, encoding or carrying instructions 1024 for execution by the machine and that cause the machine to perform any one or more of the methodologies of the present invention, or that is capable of storing, encoding or carrying data structures utilized by or associated with such instructions 1024. The term “machine-readable medium” shall accordingly be taken to include, but not be limited to, solid-state memories, and optical and magnetic media. Specific examples of machine-readable media include non-volatile memory, including by way of example, semiconductor memory devices, e.g., erasable programmable read-only memory (EPROM), electrically erasable programmable read-only memory (EEPROM), and flash memory devices; magnetic disks, such as internal hard disks and removable disks; magneto-optical disks; and CD-ROM and DVD-ROM disks.

The instructions 1024 may further be transmitted or received over the network 106 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding or carrying instructions 1024 for execution by the machine, and includes digital or analog communications signals or other intangible media to facilitate communication of such software.

In various example examples, one or more portions of the network 140 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 106 or a portion of the network 106 may include a wireless or cellular network, and a coupling may be a Code Division Multiple Access (CDMA) connection, a Global System for Mobile communications (GSM) connection, or another type of cellular or wireless coupling. In this example, a coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology. Although an example has been described with reference to specific examples, it will be evident that various modifications and changes may be made to these examples without departing from the broader spirit and scope of the invention. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1024 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to various devices. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” “device-readable medium,” and “machine storage medium,” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

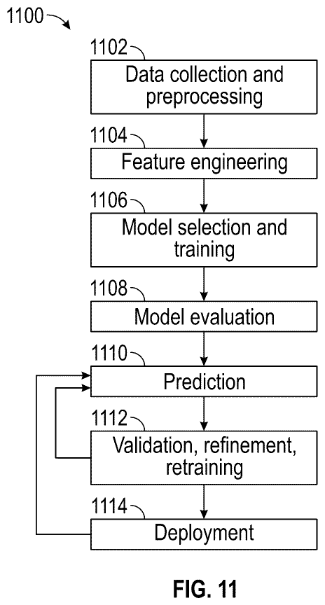

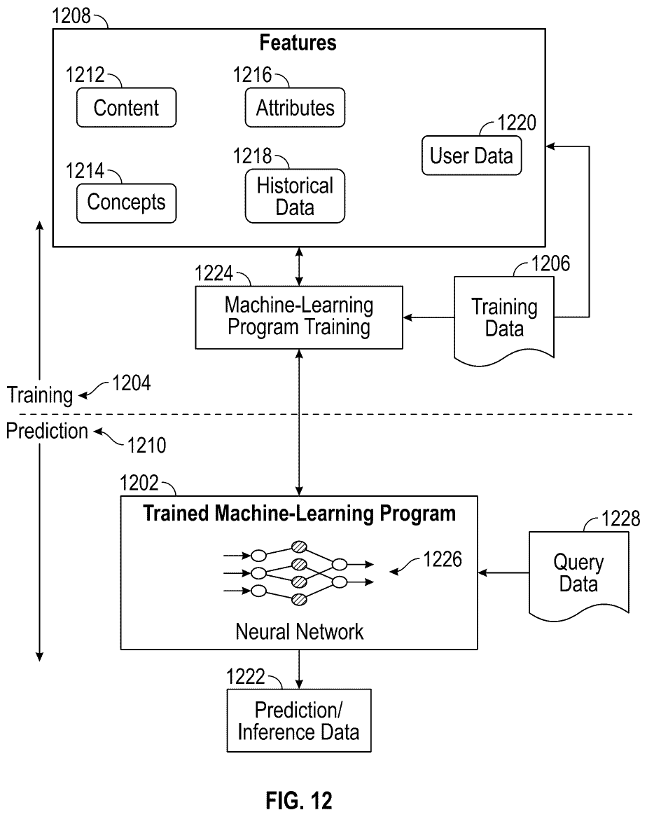

FIG. 11 depicts machine learning (ML) pipeline 1100 and FIG. 8 illustrates training and use of an ML program 1202, in accordance with some examples. While the discussion in FIGS. 11 and 12 focuses on machine learning models, this discussion is equally applicable to multimodal large language learning models where appropriate. The ML 700 can be used to generate a trained model such as the trained ML program 1202 or, in some examples, the multimodal large language learning model 150 to perform operations associated with schematic data capture.

ML may involve using computer algorithms to automatically learn patterns and relationships in data, potentially without the need for explicit programming. ML algorithms can be divided into four main categories: supervised learning, unsupervised learning, self-supervised learning, and reinforcement learning.

For example, supervised learning involves training a model using labeled data to predict an output for new, unseen inputs. Examples of supervised learning algorithms include linear regression, decision trees, and neural networks.

Unsupervised learning involves training a model on unlabeled data to find hidden patterns and relationships in the data. Examples of unsupervised learning algorithms include clustering, principal component analysis, and generative models like autoencoders.

Reinforcement learning involves training a model to make decisions in a dynamic environment by receiving feedback in the form of rewards or penalties. Examples of reinforcement learning algorithms include Q-learning and policy gradient methods.

Examples of specific ML algorithms that may be deployed, according to some examples, include logistic regression, which is a type of supervised learning algorithm used for binary classification tasks. Logistic regression models the probability of a binary response variable based on one or more predictor variables. Another example type of ML algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions.

Further examples include neural networks, which consist of interconnected layers of nodes (or neurons) that process information and make predictions based on the input data.

Matrix factorization is another type of ML algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of ML algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of ML models is typically evaluated on a separate test set of data that was not used during training to ensure that the model can generalize to new, unseen data.

Although several specific examples of ML algorithms are discussed herein, the principles discussed herein can be applied to other ML algorithms as well. Deep learning algorithms such as convolutional neural networks, recurrent neural networks, and transformers, as well as more traditional ML algorithms like decision trees, random forests, and gradient boosting may be used in various ML applications.

Two example types of problems in ML are classification problems and regression problems. Classification problems, also referred to as categorization problems, aim at classifying items into one of several category values (e.g., is this object an apple or an orange?). Regression algorithms aim at quantifying some items (for example, by providing a value that is a real number).

Turning to the training phase 1204 as described and depicted in connection with FIG. 12 and performed, at least in part, by the multimodal large language learning model 150, in some examples, generating a trained ML program 1202 may include multiple phases that form part of the ML pipeline 1100, including for example the following phases illustrated in FIG. 11: data collection and preprocessing 1102, feature engineering 1104, model selection and training 1106, model evaluation 1108, prediction 1110, validation, refinement, or retraining 1112, and deployment 1114, or a combination thereof.

For example, data collection and preprocessing 1102 can include a phase for acquiring and cleaning data to ensure that it is suitable for use in the multimodal language learning model 150. This phase may also include removing duplicates, handling missing values, and converting data into a suitable format. Feature engineering 1104 can include a phase for selecting and transforming training data (e.g., chat histories 280) to create features that are useful for predicting the target variable. Feature engineering may include (1) receiving features 1208 (e.g., as structured or labeled data in supervised learning) and/or (2) identifying features 1208 (e.g., unstructured, or unlabeled data for unsupervised learning) in training data. Model selection and training 1106 can include a phase for selecting an appropriate ML algorithm and training it on the preprocessed data. This phase may further involve splitting the data into training and testing sets, using cross-validation to evaluate the model, and tuning hyperparameters to improve performance.

In additional examples, model evaluation 1108 can include a phase for evaluating the performance of a trained model (e.g., the trained ML program 1202 or the multimodal large language learning model 150) on a separate testing dataset. This phase can help determine if the model is overfitting or underfitting and determine whether the model is suitable for deployment. The prediction 1110 phase includes using a trained model (e.g., trained ML program 1202 or the multimodal large language learning model 150) to generate predictions on new, unseen data. Validation, refinement, or retraining 1112 can include a phase for updating a model based on feedback generated from the prediction phase, such as new data, or user feedback. Deployment 1114 can include a phase for integrating the trained model (e.g., the trained ML program 1202 or the multimodal large language learning model 150) into a more extensive system or application, such as the messaging system 126 or another web service, a mobile app, or an IoT device. This phase can involve setting up APIs, building a user interface, and ensuring that the model is scalable and can handle large volumes of data.

FIG. 12 illustrates further details of two example phases, namely a training phase 1204 (e.g., part of the model selection and training 1106), which is an example of the model training performed by the model training component 250, and a prediction 1210 phase (part of the prediction 1110 phase). Prior to the training phase 1204, feature engineering 1104 is used to identify features 1208. This may include identifying informative, discriminating, and independent features for effectively operating the trained ML program 1202 in pattern recognition, classification, and regression. In some examples, the training data 1206 (e.g., chat histories 280), includes labeled data, known for pre-identified features 1208 and one or more outcomes. Each of the features 1208 may be a variable or attribute, such as an individual measurable property of a process, article, system, or phenomenon represented by a data set (e.g., the training data 1206). Features 1208 may also be of different types, such as numeric features, strings, and graphs, and may include one or more of content 1212, concepts 1214, attributes 1216, historical data 1218, and/or user data 1220, merely for example and not limitation.

In the training phase 1204, the ML pipeline 1100 uses the training data 1206 to find correlations among the features 1208 that affect a predicted outcome or prediction/inference data 1222. By way of non-limiting example, the training data 1206 can include a corpus of messages from multiple chat histories 280 between users of the messaging system 126.

With the training data 1206 and the identified features 1208, the trained ML program 1202 is trained during the training phase 1204 during ML program training 1224. The ML program training 1224 appraises values of the features 1208 as they correlate to the training data 1206. The result of the training is the trained ML program 1202 (e.g., a trained or learned model such as the multimodal language learning model 150).

Further, the training phase 1204 may involve ML, in which the training data 1206 is structured (e.g., labeled during preprocessing operations). The trained ML program 1202 implements a neural network 1226 capable of performing, for example, classification and clustering operations. In other examples, the training phase 1204 may involve deep learning, in which the training data 1206 is unstructured, and the trained ML program 1202 implements a deep neural network 1226 that can perform both feature extraction and classification/clustering operations.

In some examples, a neural network 1226 may be generated during the training phase 1204 and implemented within the trained ML program 1202. The neural network 1226 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 1226 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 1226 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1204, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In the prediction 1110 phase, the trained ML program 1202 uses the features 1208 for analyzing query data 1228 to generate inferences, outcomes, or predictions, as examples of a prediction/inference data 1222. For example, during prediction 1110 phase, the trained ML program 1202 generates an output. Query data 1228 is provided as an input to the trained ML program 1202, and the trained ML program 1202 generates the prediction/inference data 1222 as output, responsive to receipt of the query data 1228.

In some examples, the trained ML program 1202 may be a generative AI model such as an LLM. Generative AI is a term that may refer to any type of artificial intelligence that can create new content from training data 1206. For example, generative AI can produce text, image contents, video, audio, code, or synthetic data similar to the original data but not identical.

Some of the techniques that may be used in generative AI are: Convolutional Neural Networks, Recurrent Neural Networks, generative adversarial networks, variational autoencoders, transformer models, and the like. For example, Convolutional Neural Networks (CNNs) can be used for image content recognition and computer vision tasks. CNNs may, for example, be designed to extract features from image contents by using filters or kernels that scan the input image content and highlight important patterns. Recurrent Neural Networks (RNNs) can be used for processing sequential data, such as speech, text, and time series data, for example. RNNs employ feedback loops that allow them to capture temporal dependencies and remember past inputs. Generative adversarial networks (GANs) can include two neural networks: a generator and a discriminator. The generator network attempts to create realistic content that can “fool” the discriminator network, while the discriminator network attempts to distinguish between real and fake content. The generator and discriminator networks compete with each other and improve over time. Variational autoencoders (VAEs) can encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models can use attention mechanisms to learn the relationships between different parts of input data (such as words or pixels) and generate output data based on these relationships. Transformer models can handle sequential data, such as text or speech, as well as non-sequential data, such as image contents or code. In generative AI examples, the output prediction/inference data 1222 can include predictions, translations, summaries, media content, and the like, or some combination thereof.

Described implementations of the subject matter can include one or more features, alone or in combination, as illustrated below by way of example.

Example 1 is a system for augmenting a first listing, the system comprising: at least one processor; and memory comprising instructions that, when executed by the at least one processor, cause the system to perform operations comprising: receiving an image content of a first item associated with the first listing; extracting a first vector representation comprising a first characteristic from the image content; searching a category corpus for a second vector representation comprising a second characteristic using the first vector representation, the category corpus comprising second vector representations associated with the second items; comparing the first characteristic with the second characteristic; determining a match between the first vector representation and the second vector representation based on comparing the first characteristic with the second characteristic, the second characteristic being associated with a second item that is associated with a second listing; augmenting the first listing based on the second listing; and displaying the augmented first listing.

In Example 2, the subject matter of Example 1 includes, wherein the second vector representations correlate to second listing frameworks, the second listing frameworks comprising types of listing information and the operation of augmenting the first listing based on the second listing further comprises augmenting the first listing based on a second listing framework.

In Example 3, the subject matter of Examples 1-2 includes, wherein the instructions further cause the system to perform operations comprising: receiving image contents of the second items; extracting the second vector representations from the image content of the second items; and generating second listing frameworks with the second vector representations for the category corpus.

In Example 4, the subject matter of Examples 1-3 includes, wherein the image content of the first item includes an indicator and the instructions further cause the system to perform operations comprising: generating listing information based on data associated with the indicator; and augmenting the first listing with the listing information.

In Example 5, the subject matter of Example 4 includes, wherein the indicator includes an indicator image content and the instructions further cause the system to perform operations comprising: converting the indicator image content to indicator text; generating the listing information to include the indicator text; and augmenting the first listing with the indicator text.

In Example 6, the subject matter of Example 5 includes, wherein the instructions further cause the system to perform operations comprising: determining a location associated with displaying the augmented first listing; converting the indicator text from a first format to a second format based on the location; and augmenting the first listing with the converted indicator text.

In Example 7, the subject matter of Examples 1-6 includes, wherein the image content is received with an audio component and the instructions further cause the system to perform operations comprising: extracting a first audio vector representation from the audio component, the first audio vector representation having a first audio characteristic; searching the category corpus for a second audio vector representation using the first audio vector representation, the second audio vector representation having a second audio characteristic; comparing the first audio characteristic with the second audio characteristic; determining a match between the first audio vector representation and the second audio vector representation based on comparing the first audio characteristic with the second audio characteristic; and augmenting the first listing based on first audio characteristic.

In Example 8, the subject matter of Examples 1-7 includes, wherein the first characteristic includes first text having a first sequence and the second characteristic includes second text having a second sequence, wherein the instructions further cause the system to perform operations comprising: rearranging the first text from the first sequence to the second sequence; and augmenting the first listing to include the first text having the second sequence.

Example 9 is a non-transitory machine storage medium having instructions embodied thereon, the instructions executable by a processor of a machine to perform operations comprising: receiving an image content of a first item associated with the first listing; extracting a first vector representation comprising a first characteristic from the image content; searching a category corpus for a second vector representation comprising a second characteristic using the first vector representation, the category corpus comprising second vector representations associated with the second items; comparing the first characteristic with the second characteristic; determining a match between the first vector representation and the second vector representation based on comparing the first characteristic with the second characteristic, the second characteristic being associated with a second item that is associated with a second listing; augmenting the first listing based on the second listing; and displaying the augmented first listing.

In Example 10, the subject matter of Example 9 includes, wherein the second vector representations correlate to second listing frameworks, the second listing frameworks comprising types of listing information and the operation of augmenting the first listing based on the second listing further comprises augmenting the first listing based on a second listing framework.

In Example 11, the subject matter of Examples 9-10 includes, the operations further comprising: receiving image contents of the second items; extracting the second vector representations from the image content of the second items; and generating second listing frameworks with the second vector representations for the category corpus.

In Example 12, the subject matter of Examples 9-11 includes, wherein the image content of the first item includes an indicator and the operations further comprise: generating listing information based on data associated with the indicator; and augmenting the first listing with the listing information.

In Example 13, the subject matter of Example 12 includes, wherein the indicator includes an indicator image content and the operations further comprise: converting the indicator image content to indicator text; generating the listing information to include the indicator text; augmenting the first listing with the indicator text; determining a location associated with displaying the augmented first listing; converting the indicator text from a first format to a second format based on the location; and augmenting the first listing with the converted indicator text.

In Example 14, the subject matter of Examples 9-13 includes, wherein the image content is received with an audio component and the instructions further cause the system to perform operations comprising: extracting a first audio vector representation from the audio component, the first audio vector representation having a first audio characteristic; searching the category corpus for a second audio vector representation using the first audio vector representation, the second audio vector representation having a second audio characteristic; comparing the first audio characteristic with the second audio characteristic; determining a match between the first audio vector representation and the second audio vector representation based on comparing the first audio characteristic with the second audio characteristic; and augmenting the first listing based on first audio characteristic.

In Example 15, the subject matter of Examples 9-14 includes, wherein the first characteristic includes first text having a first sequence and the second characteristic includes second text having a second sequence, wherein the instructions further cause the system to perform operations comprising: rearranging the first text from the first sequence to the second sequence; and augmenting the first listing to include the first text having the second sequence.

Example 16 is a method comprising: receiving an image content of a first item associated with the first listing; extracting a first vector representation comprising a first characteristic from the image content; searching a category corpus for a second vector representation comprising a second characteristic using the first vector representation, the category corpus comprising second vector representations associated with the second items; comparing the first characteristic with the second characteristic; determining a match between the first vector representation and the second vector representation based on comparing the first characteristic with the second characteristic, the second characteristic being associated with a second item that is associated with a second listing; augmenting the first listing based on the second listing; and displaying the augmented first listing.

In Example 17, the subject matter of Example 16 includes, wherein the second vector representations correlate to second listing frameworks, the second listing frameworks comprising types of listing information and the operation of augmenting the first listing based on the second listing further comprises augmenting the first listing based on a second listing framework.

In Example 18, the subject matter of Examples 16-17 includes, the method further comprising: receiving image contents of the second items; extracting the second vector representations from the image content of the second items; and generating second listing frameworks with the second vector representations for the category corpus.

In Example 19, the subject matter of Examples 16-18 includes, wherein the image content of the first item includes an indicator having an indicator image content and the method further comprises: generating listing information based on data associated with the indicator; augmenting the first listing with the listing information.

In Example 20, the subject matter of Examples 16-19 includes, wherein the image content is received with an audio component and the instructions further cause the system to perform operations comprising: extracting a first audio vector representation from the audio component, the first audio vector representation having a first audio characteristic; searching the category corpus for a second audio vector representation using the first audio vector representation, the second audio vector representation having a second audio characteristic; comparing the first audio characteristic with the second audio characteristic; determining a match between the first audio vector representation and the second audio vector representation based on comparing the first audio characteristic with the second audio characteristic; and augmenting the first listing based on first audio characteristic.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A system comprising:
at least one processor; and
memory comprising instructions that, when executed by the at least one processor, cause the system to perform operations comprising:
receiving an image content of a first item associated with a first listing;
extracting a first vector representation comprising a first characteristic from the image content;
searching a category corpus for a second vector representation comprising a second characteristic using the first vector representation, the category corpus comprising second vector representations associated with the second items;
comparing the first characteristic with the second characteristic;
determining a match between the first vector representation and the second vector representation based on comparing the first characteristic with the second characteristic, the second characteristic being associated with a second item associated with a second listing;
augmenting the first listing based on the second listing; and
displaying the augmented first listing.

2. The system of claim 1, wherein the second vector representations correlate to second listing frameworks, the second listing frameworks comprising types of listing information and the operation of augmenting the first listing based on the second listing further comprises augmenting the first listing based on a second listing framework.

3. The system of claim 1, wherein the instructions further cause the system to perform operations comprising:
receiving image contents of the second items;
extracting the second vector representations from the image contents of the second items; and
generating second listing frameworks with the second vector representations for the category corpus.

4. The system of claim 1, wherein the image content of the first item includes an indicator and the instructions further cause the system to perform operations comprising:
generating listing information based on data associated with the indicator; and
augmenting the first listing with the listing information.

5. The system of claim 4, wherein the indicator includes an indicator image content and the instructions further cause the system to perform operations comprising:
converting the indicator image content to indicator text;
generating the listing information to include the indicator text; and
augmenting the first listing with the indicator text.

6. The system of claim 5, wherein the instructions further cause the system to perform operations comprising:
determining a location associated with displaying the augmented first listing;
converting the indicator text from a first format to a second format based on the location; and
augmenting the first listing with the converted indicator text.

7. The system of claim 1, wherein the image content is received with an audio component and the instructions further cause the system to perform operations comprising:
extracting a first audio vector representation from the audio component, the first audio vector representation having a first audio characteristic;
searching the category corpus for a second audio vector representation using the first audio vector representation, the second audio vector representation having a second audio characteristic;
comparing the first audio characteristic with the second audio characteristic;
determining a match between the first audio vector representation and the second audio vector representation based on comparing the first audio characteristic with the second audio characteristic; and
augmenting the first listing based on first audio characteristic.

8. The system of claim 1, wherein the first characteristic includes first text having a first sequence and the second characteristic includes second text having a second sequence, wherein the instructions further cause the system to perform operations comprising:
rearranging the first text from the first sequence to the second sequence; and
augmenting the first listing to include the first text having the second sequence.

9. A machine-storage medium having instructions embodied thereon, the instructions executable by a processor of a machine to perform operations comprising:
receiving an image content of a first item associated with a first listing;
extracting a first vector representation comprising a first characteristic from the image content;
searching a category corpus for a second vector representation comprising a second characteristic using the first vector representation, the category corpus comprising second vector representations associated with the second items;
comparing the first characteristic with the second characteristic;
determining a match between the first vector representation and the second vector representation based on comparing the first characteristic with the second characteristic, the second characteristic being associated with a second item that is associated with a second listing;
augmenting the first listing based on the second listing; and
displaying the augmented first listing.

10. The machine storage medium of claim 9, wherein the second vector representations correlate to second listing frameworks, the second listing frameworks comprising types of listing information and the operation of augmenting the first listing based on the second listing further comprises augmenting the first listing based on a second listing framework.

11. The machine storage medium of claim 9, the operations further comprising:
receiving image contents of the second items;
extracting the second vector representations from the image content of the second items; and
generating second listing frameworks with the second vector representations for the category corpus.

12. The machine storage medium of claim 9, wherein the image content of the first item includes an indicator and the operations further comprise:
generating listing information based on data associated with the indicator; and
augmenting the first listing with the listing information.

13. The machine storage medium of claim 12, wherein the indicator includes an indicator image content and the operations further comprise:
converting the indicator image content to indicator text;
generating the listing information to include the indicator text;
augmenting the first listing with the indicator text;
determining a location associated with displaying the augmented first listing;
converting the indicator text from a first format to a second format based on the location; and
augmenting the first listing with the converted indicator text.

14. The machine storage medium of claim 9, wherein the image content is received with an audio component and the operations further comprise:
extracting a first audio vector representation from the audio component, the first audio vector representation having a first audio characteristic;
searching the category corpus for a second audio vector representation using the first audio vector representation, the second audio vector representation having a second audio characteristic;
comparing the first audio characteristic with the second audio characteristic;
determining a match between the first audio vector representation and the second audio vector representation based on comparing the first audio characteristic with the second audio characteristic; and
augmenting the first listing based on first audio characteristic.

15. The machine storage medium of claim 9, wherein the first characteristic includes first text having a first sequence and the second characteristic includes second text having a second sequence, wherein the operations further comprise:
rearranging the first text from the first sequence to the second sequence; and
augmenting the first listing to include the first text having the second sequence.

16. A method comprising:
receiving an image content of a first item associated with a first listing;
extracting a first vector representation comprising a first characteristic from the image content;
searching a category corpus for a second vector representation comprising a second characteristic using the first vector representation, the category corpus comprising second vector representations associated with the second items;
comparing the first characteristic with the second characteristic;
determining a match between the first vector representation and the second vector representation based on comparing the first characteristic with the second characteristic, the second characteristic being associated with a second item that is associated with a second listing;
augmenting the first listing based on the second listing; and
displaying the augmented first listing.

17. The method of claim 16, wherein the second vector representations correlate to second listing frameworks, the second listing frameworks comprising types of listing information and the augmenting the first listing based on the second listing further comprises augmenting the first listing based on a second listing framework.

18. The method of claim 16, the method further comprising:
receiving image contents of the second items;
extracting the second vector representations from the image content of the second items; and
generating second listing frameworks with the second vector representations for the category corpus.

19. The method of claim 16, wherein the image content of the first item includes an indicator having an indicator image content and the method further comprises:
generating listing information based on data associated with the indicator;
augmenting the first listing with the listing information.
converting the indicator image content to indicator text;
generating the listing information to include the indicator text;
augmenting the first listing with the indicator text;
determining a location associated with displaying the augmented first listing;
converting the indicator text from a first format to a second format based on the location; and
augmenting the first listing with the converted indicator text.

20. The method of claim 16, wherein the image content is received with an audio component and the method comprises:
extracting a first audio vector representation from the audio component, the first audio vector representation having a first audio characteristic;
searching the category corpus for a second audio vector representation using the first audio vector representation, the second audio vector representation having a second audio characteristic;
comparing the first audio characteristic with the second audio characteristic;
determining a match between the first audio vector representation and the second audio vector representation based on comparing the first audio characteristic with the second audio characteristic; and
augmenting the first listing based on first audio characteristic.
